(19) United States
(12) Patent Application Publication
(10) Pub. No.: US 2009/0052294 A1
(43) Pub. Date: Feb. 26, 2009

(54) INFORMATION RECORDING MEDIUM, INFORMATION REPRODUCING APPARATUS AND INFORMATION REPRODUCING METHOD

(75) Inventor: Hiromi Honma, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 11/908,992

(22) PCT Filed: Mar. 15, 2006
(86) PCT No.: PCT/JP2006/305124

§ 371 Date: Sep. 18, 2007

(30) Foreign Application Priority Data
Mar. 18, 2005 (JP) 2005-078947

(51) Int. Cl. G11B 7/00

(52) U.S. Cl. 369/59.19; 369/59.1; G9B/7

(57) ABSTRACT

A data reproducing apparatus includes a data pulse generating section and a detector section which converts a readout signal reproduced from a data recording medium into a binary data in synchronization with the readout signal to output the binary data as a pulsed output signal. The detector section outputs a determination result indicating whether or not the data pulse generating section is in asynchronization, to the data pulse generating section based on the pulsed output signal. When the determination result indicates the asynchronization, the data pulse generating section sets a predetermined fixed operation parameter and carries out a recovering operation from the asynchronization.

### TECHNICAL FIELD

The present invention relates to an information recording medium such as an optical disc, and an information reproducing apparatus and information reproducing method, and more particularly to a stabilization of a closed loop system for controlling an operation.

### BACKGROUND ART

In accompaniment with the advancement of use of multi-media in recent years, a large amount of information including image information is required to be processed. Also, a capacity of a storage unit for recording the information is required to be larger. In particular, the capacity equal to or greater than that of a current DVD (Digital Versatile Disc) is desired in a storage field of the image information of high image quality. However, in order to increase the storage capacity of an optical disc apparatus or HDD (Hard Disc Drive) apparatus, the record density is required to be made higher. In association with this, reduction in an error rate and reservation of reliability become important. On the contrary, in the optical disc, a consideration has been roughly performed from the 3 directions such as a medium composition approach, an optical approach and a signal processing approach. The signal processing approach will be mainly described below.

In an optical disc apparatus, a laser beam is optically collected by an optical unit and is irradiated onto a disc medium, and record information is detected in accordance with the lightness and darkness of a reflection laser beam or a polarization of the reflection laser beam. The optically collected beam spot is definite, and as its diameter is smaller, the record reproduction is possible in a higher density. Thus, the optical approach to reduce this beam spot has been advanced. The spot diameter is proportional to NA (Natural Aperture) of an objective lens and inversely proportional to the wavelength λ of the laser beam. Thus, by increasing the NA of the objective lens and decreasing the wavelength λ of the laser beam, it is possible to decrease the spot diameter. However, if the NA of the objective lens is increased, a focal depth becomes shallow, and the distance between the disc surface and the lens is required to be shorter, which introduces a limit. On the other hand, a short wavelength laser has problems in the stability of a high output oscillation, the longer life and the like. However, the shorter wavelength has been gradually advanced such as an infrared laser (λ=780 nm) in CD (Compact Disc) and a blue laser (λ=495 nm) in a next generation DVD.

By the way, the frequency characteristic of a propagation path between an optical head and the disc medium becomes the same characteristic as in case of use of an LPF (Low Pass Filter) in which a gain in a high frequency range decreases due to the definite beam spot. For this reason, even if a rectangular wave is recorded onto the recording medium, the waveform is made dull. If a record density is made higher while keeping its state, the waveform to be read in a particular time interferes with a waveform of a different time. This is called an inter-symbol interference. Because of this inter-symbol interference, it is difficult to reproduce a short record mark of a certain length or less. Oppositely, if the record mark is long, a frequency is decreased that the phase information for extraction of a synchronous clock is outputted, which causes the asynchronization. Thus, the record mark is required to be limited to a range in length.

Under the above constraints, as the signal processing approach to record a signal to the recording medium, a record data on the optical disc is coded. In particular, an RLL code (Run Length Limited Code) in which a distance between inversion codes is limited is used in many cases. ETM (Eight to Twelve Modulation), EFM (Eight to Fourteen Modulation), (1,7) RLL, (2,7) RLL, 8/16 codes and the like are used. The ETM is the (1,10) RLL code, as described in “Eight to Twelve Modulation Code for High Density Optical Disk”, (International Symposium on Optical Memory 2003, Technical Digest pp. 160-161, Nov. 3, 2003) by Kinji koyanuma, et al. Although a coding rate is 2/3 similar to the (1,7) RLL, the feature is in a limit on the successive number of the shortest marks, and DC component compression performance.

Also, there is a technique referred to as waveform equalization. This technique reduces an error rate by inserting an inverse filter to remove the inter-symbol interference. This waveform equalization suppresses the inter-symbol interference since emphasizing a high frequency range component of a readout signal. However, this also emphasizes the high frequency region component of noise. For this reason, there is a case that SNR (Signal to Nose Ratio) of the readout signal is deteriorated. In particular, when a record density is higher, this deterioration in the SNR caused by this waveform equalization is a main factor of an error of the detection data. A PR (Partial Response) equalization is one method of the waveform equalization that intentionally generates the known inter-symbol interference. Usually, the high frequency region components are not emphasized, which can suppress the deterioration in the SNR.

On the other hand, as the most effective detection method of the data, the maximum likelihood detection method is known. In this method, the detection performance is improved by selecting a component in which a root mean square of error becomes minimal, from the considerable all temporal series patterns, for the data sequence in which a certain state transition is known. However, it is difficult to perform the above process on the actual circuit, in view of a circuit scale and an operation speed. For this reason, typically, this is attained by using an algorism referred to as a Viterbi algorism and iteratively performing the selection of the path. This detecting method is referred to as a Viterbi detection.

The detecting method in which the Viterbi detection with the PR equalization are combined is referred to as a PRML (Partial Response Maximum Likelihood) method and can detect the data while carrying out an error correction of a kind. The readout signal obtained through the PR equalization has a correlation in a temporal direction. For this reason, only a particular state transition appears on a data system obtained by sampling the readout signal. The limited state transition and the state transition of the data system of the actual readout signal including the noise are compared with each other, and the maximum likelihood state transition is selected. Thus, the error of the detection data can decreased. A PRML detection method of using the ETM code and the PR (1,2,2,2,1) channel can obtain a wide detection margin at the time of a high density record reproduction, as described in [Development of HD DVD drive technology (Recording Technology)] (Image Information Media Institute Technique Report ITE Technical Report Vol. 28, No. 43, pp. 17-20 MMS2004-38, CE2004-39 (July, 2004) by Ogawa, Honma et al.

In order to use the Viterbi detection and improve the detection performance, it is necessary to make the frequency characteristics of a read channel to coincide with a particular PR equalization property. In that case, the PR equalization property is selected that is as close as possible to the frequency characteristics of the reproduction channel. Typically, a waveform equalizer is used to compensate the frequency characteristics, to make it equal to a predetermined PR property as much as possible.

As a technique that adaptively compensates the aged deterioration in a signal and improves the detection performance, there is an automatic equalizing method or adaptive equalizing method. As an adaptive equalizing algorism of a sequential type, a zero forcing method, a mean square method and the like are especially typical, as described in “Base of Modern Information Communication” by Shuzo Saito et al. (Ohmsha, Ltd; November. 1992, pp. 212-217). The adaptive equalizing technique has a large effect that the initial adjustment of the apparatus is not required. A circuit for attaining the adaptive equalization includes a large number of multipliers and integrators so that it has a difficulty in view of a circuit scale. However, they are substantially solved by the advancement of the processing technique in recent years.

In order to improve the detection performance of the Viterbi detection, a low frequency variation superimposed on the readout signal is required to be removed. In case of a usual HPF (High Pass Filter), a cutoff frequency is required to be made high, in order to obtain a high SNR. If the cutoff frequency is made higher, the low frequency component included in a record code itself is also cut. For this reason, there is a case that the performance is reversely deteriorated. On the other hand, a method of using an equalization error of an equalizer and generating and feeding back an offset level is disclosed in Japanese Patent Nos. 2877109 and 2888187. Consequently, it is possible to make the cutoff frequency of HPF higher without cutting the low frequency component of the record code itself.

As mentioned above, a combination of the adaptive equalization, the offset compensation and the Viterbi detection gives the great effect to the improvement of the detection performance. However, the circuits for the Viterbi detection, the adaptive equalization and the offset compensation operate in accordance with a reproduction clock signal extracted from the readout signal. Thus, once asynchronization is generated, each closed loop group in the adaptive equalization and the offset compensation has the possibility of divergence. In this case, there is no insurance that the system is automatically recovered. Thus, an asynchronization detecting unit is required, and a recovering process is required to be executed depending on the detection result. However, the readout signal from the optical disc that has been recorded in a high density is low in resolution, and the wow flutter due to the deviation of a center position of the disc and the deviation of a spindle rotation number are generated. Therefore, a usual detection method has a difficulty in accurate asynchronization detection. Also, when the sensibility of the asynchronization is too high or too low, there is a problem. In case that the sensibility is too high, although the synchronization is accomplished, the asynchronization is erroneously detected. On the other hand, in case that the sensibility is too low, irrespectively of the asynchronization, a lock state is erroneously recognized, and the reproduction error is increased.

One method to solve the above problems is disclosed in Japanese Laid Open Patent Application (JP-A-Heisei, 11-16295). FIG. 1 is a block diagram showing the configuration of an optical disc apparatus. From the output signal of an optical head 71, an FM modulation signal recorded in a wobbling track of a guide trench is extracted by a wobble signal detector section 91, and the FM modulation signal is demodulated by an FM demodulator 92, and a bi-phase code is obtained. A PLL circuit 94 detects a rotation synchronization clock from this bi-phase code, and a bi-phase demodulator 93 demodulates the bi-phase code and obtains an address signal. A spindle servo circuit 96 controls a spindle motor 97 for rotating an optical disc 70 so that the frequency and phase of the rotation synchronization clock have predetermined values.

A readout signal detector section 72 outputs recorded information as the amplitude change of an electric signal. A readout signal is controlled by an AGC (Automatic Gain Control) circuit 73 to have a constant average signal amplitude. The output of the AGC circuit 73 is sampled, quantified and digitized by an A/D converter 74. The digitized readout signal is waveform-equalized by an equalizer 75 so that it is equal to a predetermined PR property. A PLL circuit 77 uses an output signal of the equalizer 75 and detects a read synchronization signal. The read synchronization signal is sent as an operation clock signal to the A/D converter 74, the equalizer 75 and a Viterbi demodulator 76. The readout signal that is equalized to the predetermined PR property is estimated with regard to a maximum likelihood state transition by the Viterbi decoder 76 and outputted as an RLL-coded record data.

A no-signal detector section 79 detects that a non-recorded region is being reproduced, and outputs a no-signal detection flag. An asynchronization detector section 81 detects asynchronization of the PLL circuit 77 and outputs an asynchronization detection signal. Also, a timer circuit 83 uses the asynchronization detection flag and a retrieval completion flag as a trigger and outputs a pulse of a certain time. It should be noted that an OR gate 82 outputs a logical sum of the asynchronization detection flag and the retrieval completion flag. An OR gate 84 outputs the logical sum between the no-signal detection flag and the pulse. A switcher 86 switches the input to the PLL circuit 77 from the readout signal of the equalizer 75 to the rotation synchronization clock signal in response to the non-recorded region, a record region retrieval period and the asynchronization. A system controller 88 generally controls the whole.

That is, in this method, the rotation information recorded in the wobbling track of the optical disc 70 is detected by a first signal detector section (the wobble signal detector section 91, the FM demodulator 92), and the rotation synchronization clock signal is detected by the PLL circuit 94. Also, the readout signal from the optical disc 70 is detected by a second signal detector section (the readout signal detector section 72, the AGC circuit 73 and the A/D converter 74). This readout signal and the rotation synchronization clock signal are switched by a switching circuit 86 and supplied to the PLL circuit 77. At the time of a usual operation, the PLL circuit 77 gives the read synchronization clock signal synchronous with the readout signal as the operation clock signal of the second signal detector section, and for a period during which a reproducing operation is performed on the non-recorded region and for a predetermined period after the recorded region retrieval or after the asynchronization detection, the read synchronization clock signal that is synchronized with the rotation synchronization clock signal by the switcher 86 is given as the operation clock signal. Consequently, the generation of a dead lock signal at the time of the asynchronization is prevented and the reduction in the re-synchronization period is attained.

Also, a technique with regard to the recovery and convergence of the adaptive control operation of an adaptive filter is disclosed in Japanese Laid Open Patent Application (JP-P2001-052439A). According to this, a signal reproducing apparatus contains a filter, a decoder, an error detector section, an adaptive controller and a resetting unit. The filter compensates the property of a readout signal. The decoder decodes an output signal from the filter. The error detector section detects an error from the output signal of the decoder. The adaptive controller adaptively adjusts the property of the filter on the basis of the detected error. The resetting unit carries out through the adaptive controller, a resetting operation which returns the property of the filter to a predetermined initial property in accordance with the error.

Also, Japanese Laid Open Patent Application (JP-P2004-087122A) discloses a data structure of an information recording medium. In this information recording medium, at first, a sector serving as a first unit of information is defined. A segment that is composed of at least one or more sectors and serves as a second unit is defined. Moreover, an error correction block that is composed of at least one or more segments and serves as a third unit having a same boundary position as a block boundary of the error correction block is defined. In this information recording medium, the segment includes a user data recording region and middle regions arranged before and after this user data recording region. Each of the middle regions has a data region (VFO) for synchronization adjustment for the user data recording region to be next recorded. In each of the middle regions, a part of this data region is used as a partially overlapping portion of the data region for the synchronization adjustment of a next segment.

Also, Japanese Laid Open Patent Application (JP-P2004-199727A) discloses a technique with regard to a readout signal processing unit. This readout signal processing unit contains an A/D converter, an adaptive equalizer and a PLL circuit. The A/D converter quantifies an input analog readout signal and outputs a digital readout signal data. The adaptive equalizer equalizes the readout signal data in the property that is controlled in accordance with the data before and after the equalization. The PLL circuit outputs a clock signal synchronous with the readout signal data. Moreover, this readout signal processing unit further has an analog filter and a digital filter. The analog filter removes noise included in the readout signal. The digital filter is provided between the A/D converter and the adaptive equalizer and equalizes the readout signal data in accordance with a fixed property. The PLL circuit outputs the clock signal in accordance with the output of the digital filter.

In the above method, since a wobble signal is essentially required, the method cannot cope with asynchronization in a ROM disc dedicated to reproduction. Also, usually, the wobble wobble signal is set to a frequency band lower than a readout signal band in order to suppress interference with the readout signal. For example, the wobble signal frequency of DVD-R is 1/186 of a channel frequency, and in DVD+R, it is 1/32. Moreover, the wobble signal after the information is recorded receives the interference of the readout signal, and its SNR is severely degraded. Thus, even if a read channel clock signal is generated from such a wobble signal, it is difficult to adjust the phase. When the adaptive equalizer operates in the state of an out-of-phase, there is a possibility that tap coefficients are diverged or a gain is converged to zero.

In conjunction to the above description, Japanese Laid Open Patent Application (JP-A-Heisei, 10-172238) discloses an information detecting apparatus. In this information detecting apparatus of a related technique, a subtracter subtracts an offset from a digitized input sample value readout signal. The Viterbi detector section uses a subtracter output as an input. A DC level detecting circuit detects a DC level from a sample value, a path selection data detected in a Viterbi detector section, and a minimal path metric data. The output of the DC level detecting circuit is fed back as an offset amount to the subtracter.

### DISCLOSURE OF INVENTION

Therefore, it is an object of the present invention to accurately determine asynchronization of a read PLL circuit, even in case of a ROM disc in which the wobble signal cannot be obtained or in case of a low SNR of the track snaking signal and attain a high speed processing of the PLL circuit and the high stability of an adaptive equalizer and an offset compensator section.

Another object of the present invention is to improve information detection stability through PRML detection to contribute to reliability improvement of an optical disc apparatus.

In an exemplary aspect of the present invention, an information reproducing apparatus includes a data pulse generating section and a detector section. The data pulse generating section converts a readout signal reproduced from an information recording medium into a binary data in synchronization with the readout signal and outputs the binary data as a pulsed output signal. The detector section outputs a determination result indicating whether or not the data pulse generating section is in asynchronization, to the data pulse generating section in accordance with the pulsed output signal. If the determination result indicates the asynchronization, the data pulse generating section sets a predetermined fixed operation parameter and carries out a recovering operation from the asynchronization.

This detector section may have a pattern detector section and a determining section. In this information recording medium, a special pattern is written in a data region in which information is recorded in a constant interval. The pattern detector section detects the special pattern in accordance with the pulsed output signal. The pattern detector section outputs a special pattern detection signal indicating a detection interval of the special pattern. The determining section determines the asynchronization of the data pulse generating section in accordance with the detection interval and outputs the determination result.

In another aspect of the present invention, the information reproducing apparatus reproduces information from an information recording medium in which the special pattern is written in a data region in which the information is recorded, in a constant interval and has the data pulse generating section, the pattern detector section and the determining section. The data pulse generating section pulses the readout signal reproduced from the information recording medium and outputs a pulsed output signal. The pattern detector section detects the special pattern in accordance with a pulsed output signal and outputs the special pattern detection signal indicating a detection interval of the special pattern. The determining section determines whether or not the data pulse generating section is operating in synchronization with the readout signal in accordance with the special pattern detection signal, and outputs the determination result indicating whether or not the data pulse generating section is asynchronization. If the determining result indicates the asynchronization, the data pulse generating section performs a recovering operation from asynchronization.

The determining section of the present invention determines the data pulse generating section to be in the synchronization state, when the special pattern detection signal is any of the following states, that is, when the special pattern detection signal indicates that the detection interval of the special pattern is within a predetermined range, or when the special pattern is detected successively a predetermined number of times or more at a constant interval. At the time of such states, the determining section outputs the determination result indicating the synchronization state.

Also, the determining section of the present invention determines the signal pulse generating section to be in the asynchronization, when the special pattern is not detected successively the predetermined number of times or more in a predetermined interval, namely, when the special pattern is not detected in a period of the “predetermined interval”×the “predetermined number of times”. At this time, the determining section outputs the determination result indicating the asynchronization.

The data pulse generating section of the present invention has a PLL circuit. The PLL circuit extracts a channel clock signal of the readout signal in accordance with the oscillation frequency that is updated in accordance with the readout signal. If the determination result indicates the asynchronization, the PLL circuit sets a predetermined oscillation frequency and extracts the channel clock signal. This predetermined oscillation frequency may be an oscillation frequency immediately before the determination result indicates the asynchronization or may be a predetermined initial oscillation frequency. Also, at this time, a predetermined loop gain value may be set for a loop gain of the PLL circuit.

The data pulse generating section of the present invention has an offset compensator section. The offset compensator section compensates an offset of the readout signal by using an offset value that is calculated in accordance with the pulsed output signal. If the determination result indicates the asynchronization, the offset compensator section uses a predetermined offset value to compensate the offset. This predetermined offset value may be an offset value immediately before the determination result indicates the asynchronization or may be a predetermined initial offset value. Also, this value may be an offset value determined through a learning in advance based on the offset value calculated before the determination result indicates the asynchronization.

The data pulse generating section of the present invention has an adaptive equalizer. The adaptive equalizer uses tap coefficients that are updated in accordance with a signal supplied to the adaptive equalizer and the pulsed output signal, and automatically equalizes the readout signal to the predetermined frequency characteristics. If the determination result indicates the asynchronization, the adaptive equalizer uses the predetermined tap coefficients and performs equalization. The predetermined tap coefficients may be tap coefficients immediately before the determination result indicates the asynchronization or may be predetermined initial tap coefficients.

Also, the data pulse generating section of the present invention has a Viterbi detector section for converting the readout signal into the binary data through maximum likelihood detection. This Viterbi detector section uses a PR (1,2,2,1) property or PR (1,2,2,2,1) property.

Also, in another aspect of the present invention, in the information recording medium, the special patterns are preliminarily written at the constant interval to the data region in which the information is recorded. This special pattern includes a pattern indicating a VFO region in which the space of a length nT and the mark of a length nT are recorded repeatedly and successively, when n is defined as an integer between 2 and 11 and T is defined as the channel clock signal cycle of the readout signal. Also, the special pattern may be a frame synchronization pattern that includes a pattern of modulation codes such as a 13T mark pattern other than modulation codes such as an ETM modulation codes used to record a user data, which are not defined in the modulation codes. The special pattern may be both of the VFO region pattern and the frame synchronization pattern. This VFO region pattern may be arranged at the head of an ECC block to which an error correcting process is carried out when the record and the reproduction are performed, or may be arranged for each sector.

Moreover, in another aspect of the present invention, an information reproducing method has a data pulse generation step and a detection step. The data pulse generation step includes converting a readout signal reproduced from the information recording medium into a binary data in synchronization with the readout signal and outputting the binary data as a pulsed output signal. The detection step includes outputting a determination result indicating whether or not the data pulse generation step is in asynchronization, in accordance with the pulsed output signal. If the determination result indicates the asynchronization, the data pulse generation step includes setting a predetermined fixed operation parameter and carrying out a recovering operation from the asynchronization.

The detection step has a pattern detection step and a determination step. In the information recording medium, the special pattern is previously written in the data region in which the information is recorded, in a constant interval. The pattern detection step includes detecting this special pattern in accordance with the pulsed output signal and outputting the special pattern detection signal indicating the detection interval of the special pattern. The determination step includes determining the asynchronization of the data pulsing step in accordance with the detection interval and outputting the determination result.

The determination step of the present invention includes, if the special pattern detection signal is in the following states, determining this to be in the synchronization state/the asynchronization and outputting the determination result. If the special pattern detection signal indicates the fact that the detection interval to detect the special pattern is detected successively a predetermined number of times or more, in the detection interval within a predetermined range, this is determined to be in the synchronization state. If the special pattern detection signal is not detected successively the predetermined number of times or more in the detection interval, this is determined to be asynchronization.

### BRIEF DESCRIPTION OF DRAWINGS

FIG. 1 is a block diagram showing the configuration of an information reproducing apparatus in a related art;

FIG. 2 is a block diagram showing the configuration of an information reproducing apparatus according to an exemplary embodiment of the present invention;

FIG. 3 is a view showing an area configuration of a disc medium that is used in the information reproducing apparatus according to the exemplary embodiment of the present invention;

FIG. 4 is a view showing the configuration of a data row in a data region of the disc medium;

FIG. 5 is a block diagram showing the configuration of an offset compensator section in the information reproducing apparatus according to the exemplary embodiment of the present invention;

FIG. 6 is a block diagram showing the configuration of a PLL circuit in the information reproducing apparatus according to the exemplary embodiment of the present invention;

FIGS. 7A to 7C are diagrams showing a data sequence supplied to a phase comparator in the information reproducing apparatus according to the exemplary embodiment of the present invention;

FIG. 8 is a view showing the configuration of an adaptive equalizer in the information reproducing apparatus according to the exemplary embodiment of the present invention; and

FIGS. 9A to 9E are timing charts showing the operation of the information reproducing apparatus according to the exemplary embodiment of the present invention.

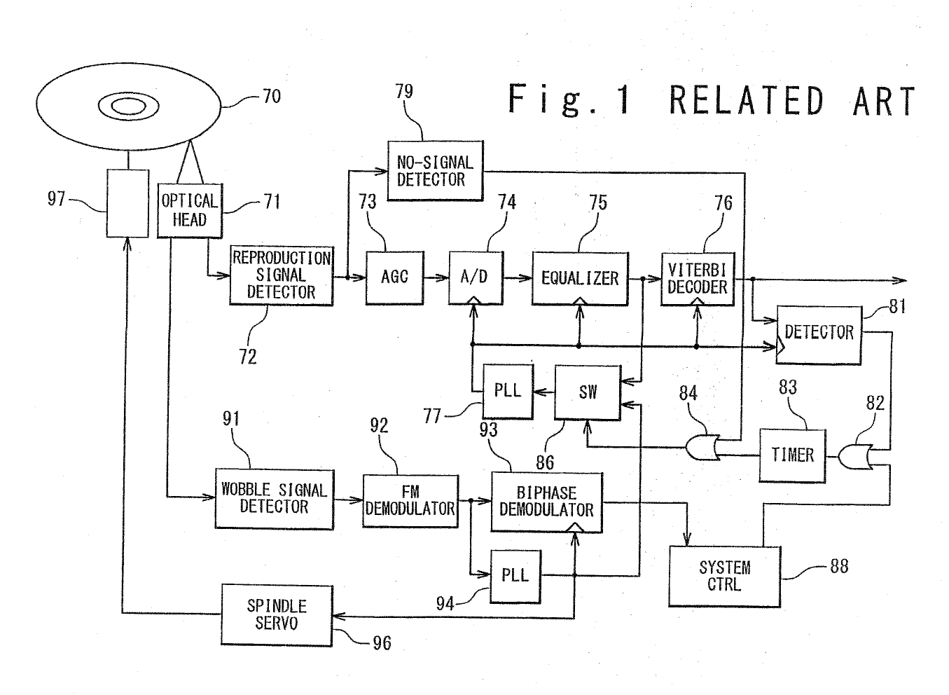

### BEST MODE FOR CARRYING OUT THE INVENTION

Hereinafter, an information reproducing apparatus for reproducing information from an information recording medium of the present invention will be described in detail with reference to the attached drawings.

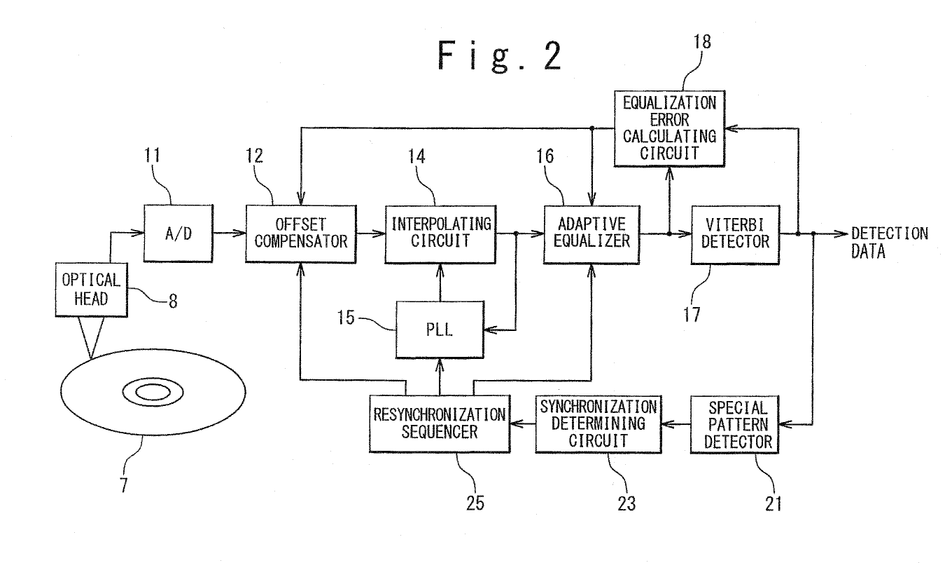

FIG. 2 is a block diagram showing the configuration of the information reproducing apparatus according to an exemplary embodiment of the present invention. With reference to FIG. 2, the information reproducing apparatus is composed of an optical head 8, an A/D converter 11, an offset compensator section 12, an interpolating circuit 14, a PLL circuit 15, an adaptive equalizer 16, a Viterbi detector section 17, an equalization error calculating circuit 18, a special pattern detector section 21, a synchronization determining circuit 23 and a re-synchronization sequencer 25.

The optical head 8 generates a readout signal from a reflection laser beam from a disc medium 7 in which special patterns are embedded at a predetermined constant interval. The readout signal is outputted to the A/D converter 11. The disc medium 7 is rotated at a constant angular velocity or constant linear velocity by a spindle motor (not shown). In the optical head 8, a servo circuit (not shown) accurately controls a distance between a disc surface and an objective lens and radius positions of a disc guide trench and a laser beam spot. The beam spot of a laser beam emitted by the optical head 8 is irradiated to a data mark recorded on the disc 7. In the reflection laser beam from the surface of the disc 7, a reflectance or polarization is changed depending on the presence or absence of the data mark. This change is detected by a detector section (not shown) of the optical head 8 and the readout signal is obtained. In the readout signal, the presence or absence of the data mark is obtained as amplitude information.

The A/D converter 11 samples the readout signal outputted from the optical head 8 with a signal having a fixed frequency and converts the sampled signal into a digital signal of a several-bit width. The readout signal passes through a filter (not shown) for the sake of aliasing removal. A clock signal for the sampling by the A/D converter 11 uses a clock signal of the fixed frequency higher than an input channel frequency. The digital readout signal is outputted to the offset compensator section 12.

The offset compensator section 12 receives the digital readout signal from the A/D converter 11, an equalization error from the equalization error calculating circuit 18, and an initial value setting signal, an initial offset value and an offset compensation hold signal from the re-synchronization sequencer 25. The offset compensator section 12 compensates an offset value of the digital readout signal in accordance with the equalization error. The digital readout signal is subjected to the offset compensation and then is outputted to the interpolating circuit 14. The detail of the offset compensator section 12 will be described later.

The interpolating circuit 14 receives the digital readout signal after the offset compensation from the offset compensator section 12, and a phase compensation data from the PLL circuit 15. The interpolating circuit 14 performs data interpolation on the digital readout signal after the offset compensation, and compensates the phase in accordance with a phase compensation data. The interpolating circuit 14 outputs the phase-compensated readout signal to the adaptive equalizer 16 and the PLL circuit 15. The phase-compensated readout signal becomes a signal as if it has been sampled in synchronization with the input channel.

The PLL circuit 15 receives the phase-compensated readout signal from the interpolating circuit 14 and an external frequency setting signal, a frequency data, a loop gain and a PLL hold signal from the re-synchronization sequencer 25. The PLL circuit 15 generates the phase compensation data in accordance with the phase-compensated readout signal to output to the interpolating circuit 14. The detail of the PLL circuit 15 will be described later.

The adaptive equalizer 16 receives the phase-compensated readout signal from the interpolating circuit 14, the equalization error from the equalization error calculating circuit 18, and the initial value setting signal, the initial tap coefficients and the equalizer hold signal from the re-synchronization sequencer 25. The adaptive equalizer 16 changes the frequency characteristics of the readout signal so that the frequency characteristics of the phase-compensated readout signal is made closer to a PR property in accordance with the equalization error. The readout signal whose frequency characteristics has been changed by the adaptive equalizer 16 is outputted to the Viterbi detector section 17 and the equalization error calculating circuit 18. The detail of the adaptive equalizer 16 will be described later.

The Viterbi detector section 17 receives the readout signal whose frequency characteristics has been changed, from the adaptive equalizer 16. The Viterbi detector section 17 converts the readout signal into a binary data through the maximum likelihood detection. The readout signal after the conversion into the binary data is outputted as a detection data to the equalization error calculating circuit 18 and the special pattern detector section 21. Also, this detection data is used by a host system after the removal of unnecessary data (a format process), demodulation of record codes, an error correction process and the like.

The equalization error calculating circuit 18 receives the output of the adaptive equalizer 16 and the detection data outputted from the Viterbi detector section 17 and calculates the equalization error. The calculated equalization error is outputted to the adaptive equalizer 16 and the offset compensator section 12. In this way, the closed loop is configured in such a way that the equalization error is fed back.

The special pattern detector section 21 receives the detection data outputted from the Viterbi detector section 17 and extracts special patterns from the detection data. The special pattern detector section 21 outputs a special pattern detection signal to the synchronization determining circuit 23 to indicate the detection of the special pattern. The determination of the special pattern by the special pattern detector section 21 is assumed to have the determination condition, which is not strict but somewhat loose so that perfect coincidence is not required even if the frequency is deviated slightly. For example, a pattern including 13T±1T is detected. In case of the ETM code, only the patterns between 2T and 11T appear in a user data 68. For this reason, a SYNC code can be detected at a high probability. Also, when VFO is used, the pattern itself appears even in the user data 68. However, when the continuation of the same patterns is considered, the detection of the high probability is possible.

The synchronization determining circuit 23 receives the special pattern detection signal outputted from the special pattern detector section 21. The synchronization determining circuit 23 measures an interval between the special pattern detections indicated by the special pattern detection signal and determines the synchronization state from the interval. When detecting asynchronization, the synchronization determining circuit 23 notifies it to the re-synchronization sequencer 25. The transition of determination from the asynchronization to the synchronization state occurs, for example, when the detected special pattern intervals are normal timings that are successive 10 times or more. Also, the transition from the synchronization state to the asynchronization occurs when the detected special pattern intervals are abnormal timings that are successively 10 times or more. Since hysteresis is given to the transition between the synchronization establishment/asynchronization, the stability of the system can be improved.

The re-synchronization sequencer 25 receives a synchronization state determination result from the synchronization determining circuit 23 and outputs a control signal and a control data to the offset compensator section 12, the PLL circuit 15 and the adaptive equalizer 16. When the asynchronization is notified from the synchronization determining circuit 23, the re-synchronization sequencer 25 starts a re-synchronization/recovering sequence. The re-synchronization sequencer may be composed of a microcomputer and firmware.

The re-synchronization sequencer 25 outputs the initial value setting signal, the initial offset value and the offset compensation hold signal to the offset compensator section 12. The offset compensation hold signal is outputted when the offset value of the offset compensator section 12 should be held in the state at that time. The initial value setting signal is outputted when the previously learned initial offset value is set to the offset compensator section 12. In the re-synchronization/recovering sequence, the initial value may be only preset or may be held after the initial value is preset. Or, this may be held in the state of an immediately before offset value.

The re-synchronization sequencer 25 outputs the external frequency setting signal, the frequency data, the loop gain and the PLL hold signal to the PLL circuit 15. In response to the external frequency setting signal, the frequency data, and the oscillation frequency and loop gain value indicated in the loop gain are preset in the PLL circuit 15. In response to the PLL hold signal, the oscillation frequency is kept in the state at that time. When the external frequency is set, its oscillation frequency may be preset by calculating the frequency on the basis of the special pattern detection interval. In the re-synchronization/recovering sequence, the oscillation frequency may be only preset, or the oscillation frequency may be only held.

The re-synchronization sequencer 25 outputs the initial value setting signal, the initial tap coefficients and the equalizer hold signal to the adaptive equalizer 16. In response to the initial value setting signal, the initial tap coefficients are reset. In response to the equalizer hold signal, the tap coefficients at that time are kept. In the re-synchronization/recovering sequence, the tap coefficients may be initialized, or the coefficients immediately before may be only held.

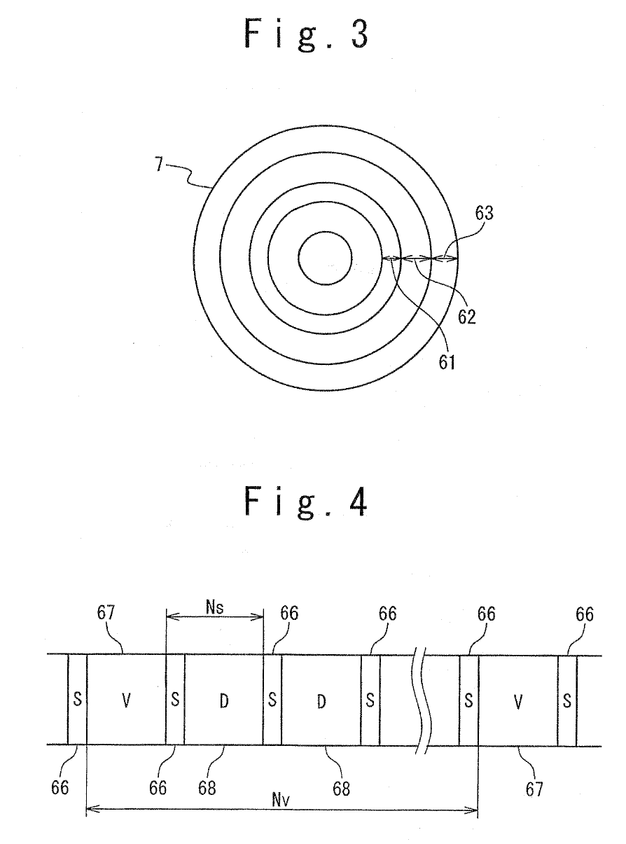

FIG. 3 shows an area configuration of the disc medium 7. The disc medium 7 has a lead-in area 61, a data area 62 and a lead-out area 63 from the inner side. A spiral recording track for recording data is formed in the data area 62. The user data is recorded along the recording track.

A data structure of the data recorded in the data area 62 can be represented 1-dimensionally as shown in FIG. 4. The special patterns are embedded in the user data in a predetermined constant interval. In the special patterns, there are two kinds of a SYNC code 66 and a VFO pattern 67. Here, those two kinds are arranged. However, any one of them may be arranged.

The SYNC code 66 is a code that includes a long mark pattern such as 13T which does not appear in an ETM modulation code rule. The SYNC code is inserted into the user data for each interval Ns. The interval Ns is assumed to be a fixed interval of several tens of bytes. This SYNC code may be used for a DSV (Digital Sum Value) adjustment at the time of the reproduction and error propagation limitation at the time of the demodulation. Also, a different SYNC code may be used.

The VFO pattern 67 is formed as the continuation of a pattern of 4T spaces and 4T marks, which appear in the ETM modulation code rule. The VFO pattern 67 is embedded for each constant interval Nv. For example, the VFO pattern 67 is arranged at the head of an ECC block and may be used for the high-speed phase reception pull-in of the PLL circuit to extract a synchronization clock signal from the readout signal. Also, any code between 2T and 11T may be used as the VFO pattern 67. In that case, the VFO pattern 67 may be arranged at the head of each sector.

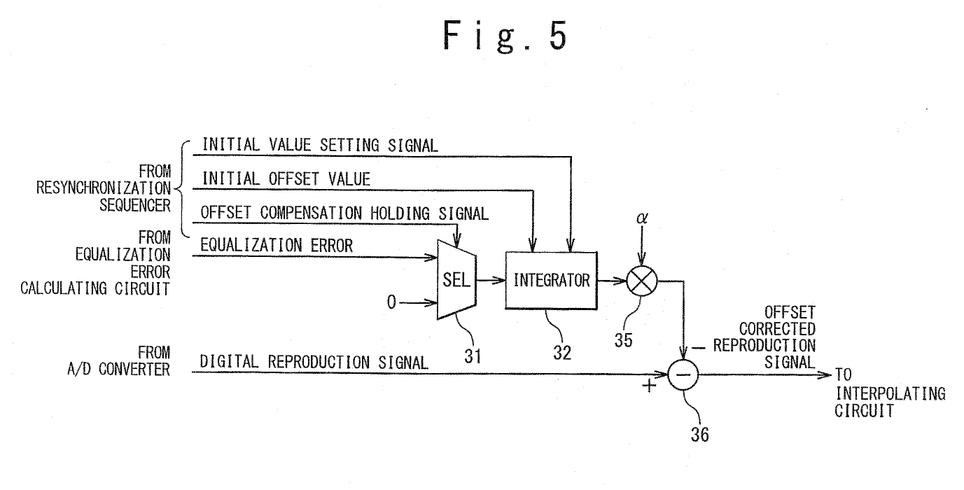

The detail of the offset compensator section 12 will be described below. As shown in FIG. 5, the offset compensator section 12 contains a selector 31, an integrator 32, a multiplier 35 and a subtracter 36. The selector 31 selects one of a signal indicating the equalization error outputted from the equalization error calculating circuit 18 and a signal indicating the constant of “0” in accordance with the offset compensation holding signal outputted from the re-synchronization sequencer 25 and outputs the selected signal as an error signal to the integrator 32. The offset compensation holding signal is a signal that becomes active only when a holding operation is required. Thus, the selector 31 usually outputs the equalization error to the integrator 32.

The integrator 32 integrates (accumulates) the error signal and outputs the integration result to the multiplier 35. Also, the integrator 32 receives the initial value setting signal and the initial offset value from the re-synchronization sequencer 25. The initial offset value is preset to the integrator 32 in response to the initial value setting signal.

The multiplier 35 multiplies the integration result by α (0<α<1) and outputs the multiplication result as an offset level correction value to the subtracter 36. The subtracter 36 subtracts the integration result from the digital readout signal supplied from the A/D converter 11 to correct the offset level. The offset corrected readout signal is outputted to the interpolating circuit 14.

When an offset in a plus direction is superimposed on the digital readout signal outputted by the A/D converter 11, the equalization error includes a more plus component. For this reason, the integration result accumulated in the integrator 32 is increased in the plus direction. The integration result is multiplied by α and is subtracted from the digital readout signal on which the offset in the plus direction is superimposed. Therefore, the system operates in such a manner that the equalization error becomes gradually zero. This coefficient α can be used to control its convergence rate. In this way, the offset level can be gradually converged.

On the other hand, when the PLL (offset compensation) holding signal becomes active, the selector 31 selects “0” instead of the equalization error and outputs the selected signal to the integrator 32. Since the value of the selected signal is “0”, the integrator 32 holds the value immediately before, Also, when the initial value setting signal becomes active, the initial offset value is preset in the integrator 32 as the integration value. Thus, the re-synchronization sequencer 25 can set the offset value.

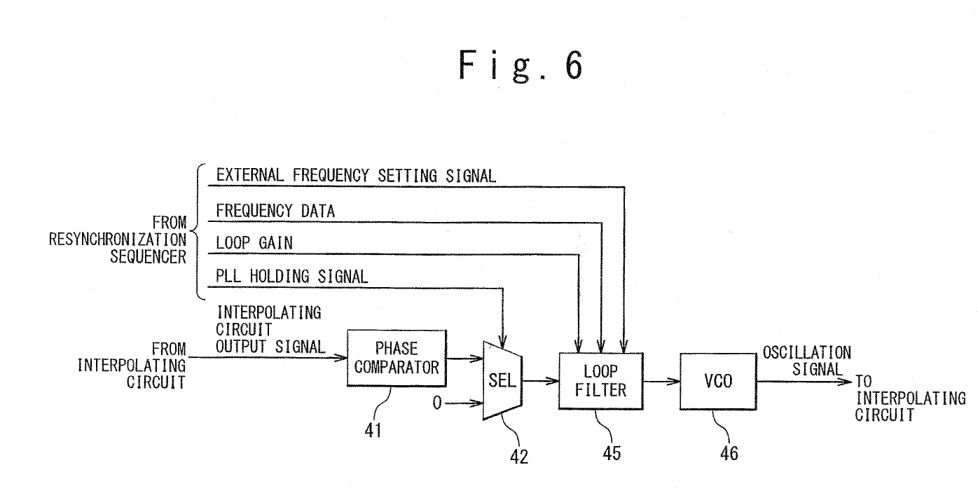

The detail of the PLL circuit 15 will be described below. As shown in FIG. 6, the PLL circuit 15 has a phase comparator 41, a selector 42, a loop filter 45 and a VCO 46. The phase comparator 41 receives a phase-corrected readout signal outputted from the interpolating circuit 14, and outputs the phase comparison result to the selector 42. A phase comparator used in a usual analog PLL circuit or the like inputs two signals for detecting the phase difference between the two signals. The phase comparator 41 is a phase comparator for comparing the phases between the input channel and the sampling. Thus, one input signal of multiple bits is used.

The selector 42 selects one of the phase comparison result outputted from the phase comparator 41 and the constant of “0” and outputs the selected data as a phase difference data to the loop filter 45, based on a PLL holding signal outputted from the resynchronization sequencer 25. The PLL holding signal is a signal that becomes active only when a holding operation is required. Thus, the selector 42 usually outputs the output of the phase comparator 41 to the loop filter 45.

The loop filter 45 calculates a frequency data to control the VCO 46 based on the phase difference data outputted from the selector 42. The calculated frequency data is outputted to the VCO 46. Also, the loop filter 45 receives an external frequency setting signal, the frequency data and a loop gain from the re-synchronization sequencer 25. When the external frequency setting signal becomes active, the loop filter 45 presets therein a frequency indicated by the frequency data and a loop gain value indicated by the loop gain. Thus, in response to the external frequency setting signal, the oscillation frequency and the loop gain can be instantly switched to the set values. Also, when the PLL holding signal becomes active, the selector 42 outputs the constant “0” as the phase difference data. Therefore, the loop filter 45 determines that there is no phase difference which involves the change of the oscillation frequency, and then keeps the oscillation frequency in its original state.

The VCO 46 receives the frequency data from the loop filter 45 and generates an oscillation signal having the shape of saw teeth in accordance with the frequency data. The inclination of this saw-teeth wave is proportional to the oscillation frequency. The generated oscillation signal is outputted as a phase compensation data to the interpolating circuit 14. The interpolating circuit 14 is controlled based on this output, and the phase synchronization loop is entirely produced.

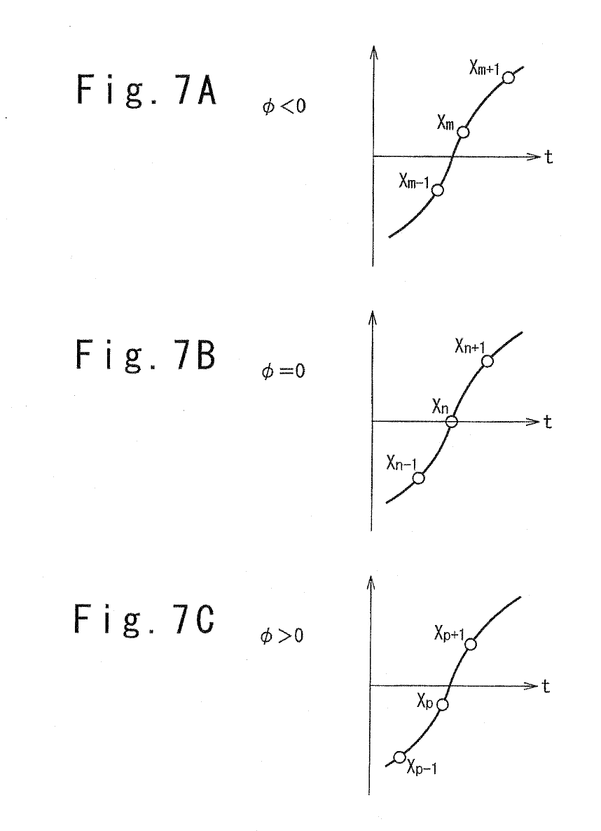

Here, with reference to FIGS. 7A to 7C, the phase comparison of the phase comparator 41 is described. FIGS. 7A to 7C show three sequences X of successive data when a phase difference Φ is different. A phase synchronizing operation is performed on the data sequence X supplied to the phase comparator 41 so that the phase difference φ becomes zero. In case of Φ=0 such as {Xn=1, Xn and Xn+1} shown in FIG. 7B, the timing across an amplitude center (at axis) becomes a sampling position. That is, Xn=0. In case of Φ<0, as shown in FIG. 7A, Xm>0. Also, in case of Φ>0, as shown in FIG. 7C, Xp<0. That is, the amplitude values of the near-sample timings (Xm, Xn and Xp) across the amplitude centers are shifted) and the Φ have a one-to-one correspond. However, depending on the inclination of the waveform, the polarity is different, thereby requiring the compensation for the polarity based on the inclination of the waveform. In this way, the input data sequences are used to determine the phase difference.

The detail of the adaptive equalizer 16 will be described below. The adaptive equalizer 16 has delay elements 51-1 to 51-4, a delay element 52, delay elements 53-1 to 53-4, correlators 54-0 to 54-4, multipliers 55-0 to 55-4, adders 56-1 to 56-4, a selector 57, and a multiplier 58.

The phase-compensated readout signal outputted from the interpolating circuit 14 is supplied to the delay element 51-1 and the delay element 52 and also supplied to the multiplier 55-0. The delay elements 51-1 to 51-4 are connected in series, and the respective output signals are supplied to the multipliers 55-1 to 55-4. The delay elements 51-1 to 51-4 are the delay elements for generating the delay of a 1-channel period (T). The delay element 52 and the delay elements 53-1 to 53-4 are connected in series, and the respective output signals are supplied to the correlators 54-0 to 54-4. The delay element 52 is the delay element for generating the delay of an n-channel period (nT), and the delay elements 53-1 to 53-4 are the delay elements for generating the delay of the 1-channel period (T). The n-channel period generated by the delay element 52 is set such that in the correlator 54-2 located at the center of the filter, the phase difference between the equalization error and the phase-compensated readout signal which is outputted by the interpolating circuit 14 becomes zero.

On the other hand, the selector 57 selects any of the constant “0” and the equalization error outputted by the equalization error calculating circuit 18 in accordance with the equalizer holding signal outputted by the re-synchronization sequencer 25 and outputs as the error signal to the multiplier 58. The equalizer holding signal is a signal that becomes active only when the holding operation is required. Thus, the selector 57 usually outputs the equalization error, which is outputted by the equalization error calculating circuit 18, to the multiplier 58. The multiplier 58 multiplies a constant “−1” by the error signal and reverses the polarity of the error signal and then outputs to each of the correlators 54-0 to 54-4.

The correlators 54-0 to 54-4 calculate the correlations between the error signal (the reverse polarity) and the delayed interpolating circuit output signals that are the outputs of the delay element 52 and 53-1 to 53-4. The correlation values calculated by the correlators 54-0 to 54-4 are outputted as the tap coefficients of the filter to the multipliers 55-1 to 55-4, respectively. Also, the correlators 54-0 to 54-4 receive the initial tap coefficients and the initial value setting signal outputted by the re-synchronization sequencer 25. In response to the initial value setting signal, the initial tap coefficients are preset to the correlators 54-0 to 54-4.

The multipliers 55-0 to 55-4 multiply the interpolating circuit output signal and the delayed interpolating circuit output signals as the outputs of the delay elements 51-1 to 51-4, and the tap coefficients calculated by the correlators 54-0 to 54-4, and output the multiplication results to the adders 56-1 to 56-4, respectively. The adders 56-1 to 56-4 calculate a sum of the outputs of the multipliers 55-0 to 55-4 and output as the equalizer output signal to the Viterbi detector section 17 and the equalization error calculating circuit 18.

In this way, a fifth-order FIR filter is exemplified as the adaptive equalizer 16. The respective tap coefficients are outputted by the corresponding correlators 54-0 to 54-4. The equalization error (the reverse polarity) and the signal prior to the equalization are supplied to each correlator 54. Thus, the phases are compensated by the delay elements 53-1 to 53-4 so that the respective taps and the phases are matched. Also, in the paths from the output of the adaptive equalizer 16 through the Viterbi detector section 17 to the output of the equalization error calculating circuit 18, the delays exist because of the Viterbi detection calculation and the equalization error calculation. In order to compensate this delay, the delay element 52 is inserted, and the phases of the two input signals to the correlator 54-2 for controlling the central tap are zero. Consequently, the correlators 54-0 to 54-4 operate in such a manner that the correlation between the two input signals are made as close as possible to zero. Also, here, the closed loop of one sort is formed. If the equalizer holding signal is active, the selector 57 outputs the constant “0” as the error signal. Thus, the adaptive equalizing operation is held. Also, if the asynchronization is generated, each tap coefficient may be preset to the initial value in response to the initial value setting signal.

In this exemplary embodiment, in the adaptive equalizer 16, the frequency characteristics is modified such that the output is made close to the PR property. This is because, although the ETM code in which the minimal successive number of the code “0” is 1 is excellent in compatibility with PRML, a ratio between the 3T mark amplitude and the long mark amplitude (3T resolution) exhibits the reproduction performance in which the PR (1,2,2,1) and Viterbi detection are excellent near 0.35. Also, it is experimentally known that the PR (1,2,2,2,1) and Viterbi detection are better than the other PR channels, in case that the 3T resolution is about 0.2. The PR (1,2,2,2,1) channel is optimal to the high-density record signal. However, of course, the other channels may be used.

In this exemplary embodiment, HPF and PR filters that are composed of analog circuits may be inserted in front of the A/D converter 11, instead of the offset compensator section 12 and the adaptive equalizer 16. Also, the PLL circuit 15 may be composed of a phase comparator+a loop filter+DAC+an analog VCO, although the full digital configuration is desirable because it is easily manufactured as the LSI and its property is uniform, as mentioned above. In this case, the interpolating circuit 14 is not required, and the PLL clock signal may be used as the sampling clock signal of the A/D converter 11.

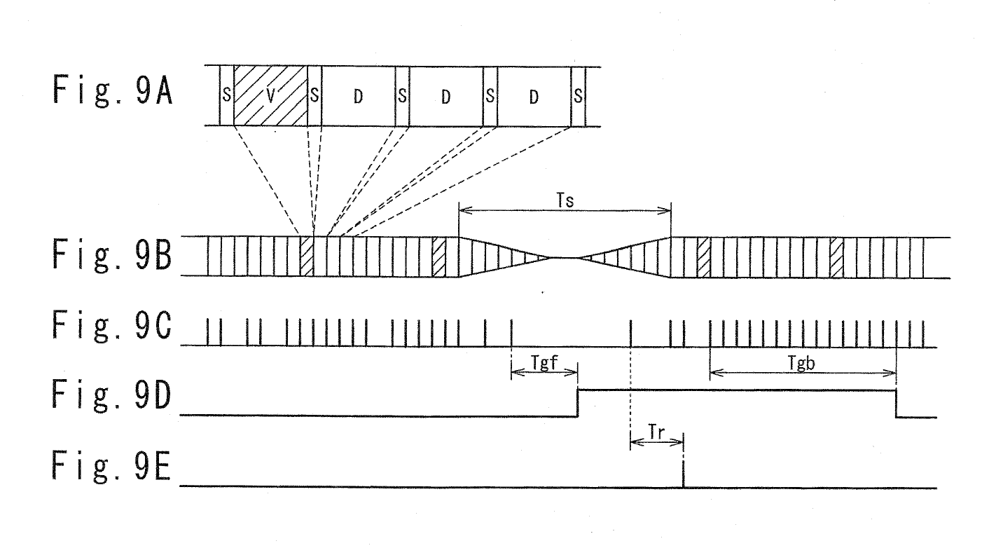

A recovering operation in case of the generation of the asynchronization will be described below with reference to FIGS. 9A to 9E. FIGS. 9A to 9E show one example, when the channel frequency is out of a desired value due to a long seek and the like. Once the apparatus is in a synchronous state, the synchronization state can be kept even if the special pattern detection errors are sometime generated. Since the readout signal is disturbed at the time of the seeking operation, the special pattern is successively detected as errors. This is detected, and the asynchronization detection becomes active. The re-synchronization sequencer 25 suppresses the closed loop divergence/oscillation in the asynchronization and holds the respective functions to prevent that the operations become unstable.

Immediately after the long seeking operation, even if the spindle is rotated under a CLV control, the rotation control of the spindle is not ready in time. As a result, the linear velocity steps out from a desired value. Consequently, the stabilization of the spindle rotation number is usually waited for. However, the throughput drops due to the waiting operation at the time of a random access. Thus, this time is required to be reduced. Therefore, the re-synchronization sequencer 25 sets the initial setting values to the respective functions, and quickly attains the re-synchronizing operation to reduce the recovery time.

FIG. 9A shows a situation of the arrangement of the special code patterns of the SYNC code/VFO code and the user data recorded on the disc medium 7. The SYNC codes are shown as regions S and arranged on the disc medium 7 in a constant interval for each several tens of bytes and the like. The VFO patterns are shown as regions V, and have a data pattern that includes the repetition of a predetermined code and is difficult to generate in the usual user data, and are arranged in a constant interval of a period longer than that of the SYNC code. The code used in the VFO pattern may be the code used in the user data.

FIG. 9B schematically shows the readout signal outputted from the optical head 8. Usually, the readout signal periodically includes the SYNC codes and the VFO patterns between the user data. Sometimes, the special code is erroneously detected or not detected because of external disturbance. However, the erroneous detection/non-detection is not successive for a long time. Thus, as shown in FIG. 9C, the detection of the special pattern is substantially performed in a constant interval.

However, the readout signal becomes unstable for a period Ts during which the long seeking operation is performed. Thus, as shown in a center of FIG. 9C, the special pattern that has been detected substantially periodically is not detected. If the special pattern is not detected for a period Tgf after the detection of the special pattern, the synchronization determining circuit 23 determines that the asynchronization is generated, as shown in FIG. 9D, and notifies the asynchronization determination result to the re-synchronization sequencer 25. This period Tgf is provided to prevent an erroneous determination. For example, this period is set to the period during which the special pattern is normally detected 10 times. If this period Tgf is set long, the response performance to the asynchronization is degraded, and if this is set short, the erroneous determination is easily caused.

When the generation of the asynchronization is notified, the re-synchronization sequencer 25 starts the re-synchronization/recovering sequence. In order to prevent the operations such as the offset compensation operation, the PLL operation and the adaptive equalizing operation from being unstable due to the asynchronization, the hold control is performed.

The holding operation of the offset compensating operation is performed by activating the offset compensation holding signal outputted from the re-synchronization sequencer 25 to the offset compensator section 12, as shown in FIG. 5. When the offset compensation holding signal becomes active, the selector 31 outputs the constant “0” to the integrator 32 as the error signal, instead of the equalization error outputted from the equalization error calculating circuit 18. For this reason, the integrator 32 continues to hold the integration value immediately before, and the offset compensating operation is held.

With reference to FIG. 6, the holding operation of the PLL operation is performed by activating the PLL holding signal outputted from the re-synchronization sequencer 25 to the PLL circuit 15. When the PLL holding signal becomes active, the selector 42 outputs the constant “0” to the loop filter 45, instead of the phase comparison result outputted from the phase comparator 41. The loop filter 45 does not change the output because the phase difference “0” is supplied. Thus, the oscillation frequency of the VCO 46 is not changed, and the PLL frequency is held.

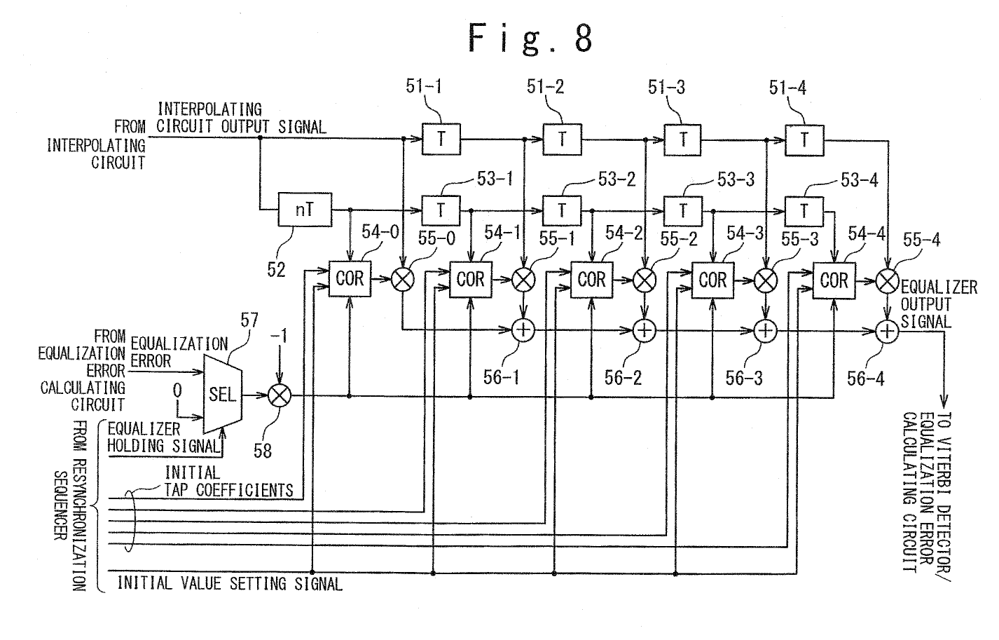

With reference to FIG. 8, the holding operation of the adaptive equalizing operation is performed by activating the equalizer holding signal outputted from the re-synchronization sequencer 25 to the adaptive equalizer 16. When the equalizer holding signal becomes active, the selector 57 outputs the constant “0” through the multiplier 58 to the correlators 54-0 to 54-4 as the error signal, instead of the equalization error outputted by the equalization error calculating circuit 18. Thus, the multiplication results of the correlators 54-0 to 54-4 become “0”, and their integration value, namely, the correlation values are held the value immediately before. The outputs of the correlators 54-0 to 54-4, namely, the tap coefficients hold the values immediately before, and the adaptive equalizing operation is held.

As shown in FIG. 9C, the detection of the special pattern is not stable immediately after the long seeking operation, because the rotation control of the spindle is not stable. Therefore, in order to reduce a recovery time from the asynchronization, for example, the re-synchronization sequencer 25 sets the initial setting value at the time point of the period Tr after the restart of the detection of the special pattern, as shown in FIG. 9E.

With reference to FIG. 5, the setting the initial value to the offset compensator section 12 is performed by setting the initial offset value and activating the initial value setting signal outputted to the offset compensator section 12. The initial value of the offset compensation is the initial offset value previously learned, and a value multiplied by a may be used. Also, this value may be a fixed value. When the initial value setting signal becomes active, the integrator 32 stores the set initial offset value therein. The integrator 32 outputs this initial offset value to the multiplier 35, and the operation is started. At this time, if the offset compensation holding signal is active, the error signal supplied to the integrator 32 is “0” Thus, the offset compensator section 12 is held in the state of this initial value.

With reference to FIG. 8, the setting the initial values setting to the adaptive equalizer 16 is performed by setting the initial coefficient data and activating the initial value setting signal outputted to the adaptive equalizer 16. As the initial coefficient data, the initial tap coefficient for each tap is kept in advance in the re-synchronization sequencer 25. When the initial value setting signal becomes active, the correlators 54-0 to 54-4 store the initial tap coefficients for the set respective taps therein. The correlators 54-0 to 54-4 output those initial tap coefficients to the multipliers 55-0 to 55-4, and the operation is started. At this time, if the equalizer holding signal is active, the error signals supplied to the correlators 54-0 to 54-4 are “0”. Thus, the adaptive equalizer 16 still uses this initial values as the tap coefficients, which are held.

With reference to FIG. 6, the setting the initial values to the PLL circuit 15 is performed by setting the frequency data and the loop gain and by activating the external frequency setting signal outputted to the PLL circuit 15. Before the re-synchronization sequencer 25 receives the asynchronization determination result, the frequency is calculated from the special pattern interval. The frequency data may be a preset fixed frequency. When the external frequency setting signal becomes active, the loop filter 45 captures therein the set frequency data and loop gain. The loop filter 45 outputs this frequency data to the VCO 46 and uses this loop gain and then starts the phase data processing operation. At this time, if the PLL holding signal is active, the phase data supplied to the loop filter 45 indicates that there is no phase difference. Thus, the PLL circuit 15 is held in the state in this setting value.

When the processing speed from the asynchronization to the synchronization state is made high, it is effective to change the PLL loop gain to a high value. In that case, since the variation caused by noise and the like is also allowed, this is required to return to the low loop gain after the synchronization establishment. Thus, preferably, the setting of the frequency data and the setting of the loop gain can be set at different timings.

In this way, the PLL circuit presets the oscillation frequency and starts the phase pull-in processing. With this, the number of the clock signals between the special patterns is compensated, thereby releasing the asynchronization. The relief of the asynchronization is performed at the stage after a period Tgb after the special pattern detection begins to be successive. In the case of FIGS. 9A to 9E, the successive 15 special patterns are detected for the period Tgb. Also, preferably, the holding operation of each function is released at the time point when the special pattern detection begins to be successive.

As described above, the SNR of the readout signal from the disc that is recorded at the high density is low, and its frequency changes to the deviation of a center axis of the disc. Under such a situation, the special patterns are previously embedded on the disc medium in a constant interval. Then, the special pattern is detected to determine whether or not the interval between the detection patterns is normal. Thus, it is possible to surely determine whether or not the PLL synchronization is attained. In response to this synchronization determination, since the control of the holding or presetting operation is performed on each of the offset compensation, the adaptive equalization and the PLL, the closed loop divergence/oscillation in the asynchronization can be suppressed, which can quickly attain the re-synchronization operation. Therefore, the system can be stabilized, so that while the performance of the PLL detection is used at a maximum, the stability can be reserved.

According to the present invention, the reproduction stability in an abnormal state such as a disc defect is improved. Thus, it is possible to provide the data reproducing apparatus in which the synchronization recovery time is reduced, and the data recording medium that is used by the data reproducing apparatus. Also, according to the present invention, the reproduction stability is improved, which can improve the throughput at the time of the reproduction.

1-28. (canceled)

29. A data reproducing apparatus comprising:
a data pulse generating section configured to convert a readout signal reproduced from a data recording medium into a binary data in synchronization with said readout signal and to output the binary data as a pulsed output signal; and
a detector section configured to output a determination result indicating whether or not said data pulse generating section is in asynchronization, to said data pulse generating section based on said pulsed output signal,
wherein when the determination result indicates the asynchronization, said data pulse generating section sets a predetermined fixed operation parameter and carries out a recovering operation from the asynchronization.

30. The data reproducing apparatus according to claim 29, wherein a special pattern is written in a data region in which the data is recorded, in a constant interval in advance, and said detector section comprises:
a pattern detector section configured to detect the special pattern based on said pulsed output signal, and to output a special pattern detection signal indicating a detection interval of the special pattern; and
a determining section configured to determine the asynchronization of said data pulse generating section based on the detection interval and to output the determination result.

31. The data reproducing apparatus according to claim 30, wherein said determining section outputs the determining result indicating the synchronization state when the special pattern detection signal indicates the detection of the special pattern in the detection interval within a predetermined time interval range, and successive detection of the special pattern a predetermined number of times or more.

32. The data reproducing apparatus according to claim 30, wherein said determining section outputs the determination result indicating the asynchronization, when the special pattern detection signal is not detected successively the predetermined number of times or more in a predetermined detection interval.

33. The data reproducing apparatus according to claim 29, wherein said data pulse generating section comprises:
a PLL circuit configured to extract a channel clock signal of said readout signal based on an oscillation frequency that is updated based on said readout signal, and
said PLL circuit sets a predetermined oscillation frequency to extract the channel clock signal when the determination result indicates the asynchronization.

34. The data reproducing apparatus according to claim 33, wherein the predetermined oscillation frequency includes the oscillation frequency immediately before the determination result indicates the asynchronization.

35. The data reproducing apparatus according to claim 34, wherein the predetermined oscillation frequency includes a predetermined initial oscillation frequency.

36. The data reproducing apparatus according to claim 33, wherein a predetermined loop gain value is set to a loop gain of said PLL circuit, when the determination result indicates the asynchronization.

37. The data reproducing apparatus according to claim 29, wherein said data pulse generating section comprises:
an offset compensator section configured to compensate an offset of said readout signal by using an offset value calculated based on the pulsed output signal, and
said offset compensator section uses a predetermined offset value to compensate the offset when the determination result indicates the asynchronization.

38. The data reproducing apparatus according to claim 37, wherein the predetermined offset value includes an offset value immediately before the determination result indicates the asynchronization.

39. The data reproducing apparatus according to claim 37, wherein the predetermined offset value includes a predetermined initial offset value.

40. The data reproducing apparatus according to claim 29, wherein said data pulse generating section comprises:
an adaptive equalizer configured to perform automatic equalization on said readout signal by using tap coefficients that are updated based on the pulsed output signal to match a predetermined frequency characteristics, and
said adaptive equalizer performs equalization by using predetermined tap coefficients when the determination result indicates the asynchronization.

41. The data reproducing apparatus according to claim 40, wherein the predetermined tap coefficients include tap coefficients immediately before the determination result indicates the asynchronization.

42. The data reproducing apparatus according to claim 40, wherein the predetermined tap coefficients include predetermined initial tap coefficients.

43. The data reproducing apparatus according to claim 29, wherein said data pulse generating section comprises:
a Viterbi detector section configured to convert said readout signal into the binary data through maximum likelihood detection.

44. The data reproducing apparatus according to claim 43, wherein said Viterbi detector section uses a PR (1,2,2,1) property or PR (1,2,2,2,1) property.

45. The data reproducing apparatus according to claim 30, wherein said special pattern includes a pattern indicating a VFO region in which a space of a length not and a mark of a length not are recorded repeatedly and successively, when n is defined as an integer between 2 and 11 and T is defined as a channel clock signal period of said readout signal.

46. The data reproducing apparatus according to claim 30, wherein said special pattern includes a frame synchronization pattern that includes a pattern other than a pattern of a modulation code used for recording the data.

47. A data reproducing method comprising:
converting a readout signal reproduced from an data recording medium into a binary data in synchronization with the readout signal, and outputting the binary data as a pulsed output signal;
generating a determination result indicating whether or not said readout signal is in asynchronization, based on the pulsed output signal;
performing a recovering operation from the asynchronization by setting a predetermined fixed operation parameter when the determination result indicates the asynchronization.

48. The data reproducing method according to claim 47, wherein a special pattern is written in a data region in which a data is recorded, in a predetermined interval in advance, and
said generating comprises:
detecting the special pattern based on the pulsed output signal, to output a special pattern detection signal indicating a detection interval of the special pattern; and
determining the asynchronization based on the detection interval to output the determination result.

49. The data reproducing method according to claim 48, wherein said determining step comprises:
outputting the determination result indicating a synchronization state when the special pattern detection signal indicates successive detection a predetermined number of times or more in a detection interval of the special pattern within a predetermined range; and
outputting the determination result indicating the asynchronization when the special pattern detection signal does not indicates the successive detection the predetermined number of times or more in the detection interval of the special pattern within the predetermined range.
